(19) United States
(12) Patent Application Publication
(10) Pub. No.: US 2009/0223581 A1
(43) Pub. Date: Sep. 10, 2009

(54) POWER STEERING GEAR HOUSING WITH BALANCED FLOW PRESSURE PORT

(75) Inventors: Kevin P. Douglas, Bay City, MI (US); Jens Haupt, Oberursel (DE); Joel E. Birsching, Vasser, MI (US); Bryan W. Cowan, Bay City, MI (US)

Correspondence Address: HOWARD & HOWARD ATTORNEYS PLLC, 450 West Fourth Street, Royal Oak, MI, 48067, US

(73) Assignee: DELPHI TECHNOLOGIES, INC., TROY, MI (US)

(21) Appl. No.: 12/371,707

(22) Filed: Feb. 16, 2009

Related U.S. Application Data
(60) Provisional application No. 61/068,200, filed on Mar. 4, 2008.

(51) Int. Cl. B62D 5/083

(52) U.S. Cl. 137/625.23

(57) ABSTRACT

A gear housing for a power steering system defines a valve bore, a pressure port, a plurality of orifices opening into the valve bore and a plurality of passageways interconnecting the plurality of orifices and the pressure port. The plurality of orifices direct a power steering fluid into the valve bore at multiple locations within the valve bore, thereby providing a balanced flow of the power steering fluid into the valve bore. The plurality of orifices is disposed about a bore axis, with each of the orifices angularly spaced about the bore axis relative to all of the other orifices.

### CROSS REFERENCE TO RELATED APPLICATION

This application claims the benefit of Provisional Patent Application Ser. No. 61/068,200, filed on Mar. 2, 2008, the disclosure of which is hereby incorporated by reference.

### BACKGROUND OF THE INVENTION

1. Field of the Invention

The subject invention generally relates to a power steering system for a vehicle, and more specifically to a gear housing of the power steering system.

2. Description of the Prior Art

Generally, vehicular power steering systems include a pump in fluid communication with a gear housing. The gear housing defines a valve bore and supports a steering valve within the valve bore. The gear housing further defines a pressure port. A fluid line is attached to the pressure port and interconnects the pump and the gear housing. A passageway interconnects the pressure port and valve bore in fluid communication, with the passageway defining an orifice into the valve bore. The pump pressurizes and circulates a power steering fluid to the gear housing, and more specifically, the pump circulates the power steering fluid through the fluid line to the pressure port, and through the passageway into the valve bore.

A typical gear housing is shown in Prior Art FIG. 1, in which the gear housing defines a single passageway, having a single orifice, interconnecting the pressure port and the valve bore. The entire volume of the power steering fluid enters the valve bore through the orifice via the passageway. Design constraints of the typical gear housings limit the area of the orifice permitting entry of the power steering fluid into the valve bore. At high fluid velocities, having the entire volume of the power steering fluid enter through the single orifice creates an unbalanced or uneven flow of the power steering fluid through the valve bore. The unbalance flow of the power steering fluid causes undesirable vibrations in the steering valve, which produces an undesirable “hissing” noise noticeable by the occupants of the vehicle.

### SUMMARY OF THE INVENTION AND ADVANTAGES

The subject invention provides a power steering system for a vehicle. The power steering system comprises a reservoir for storing a supply of a fluid. A pump is in fluid communication with the reservoir. The pump pressurizes and circulates the fluid. A gear housing defines a valve bore, a pressure port and a plurality of orifices into the valve bore. The pressure port is in fluid communication with the pump, and receives the pressurized fluid from the pump. The plurality of orifices is in fluid communication with the valve bore and the pressure port. The plurality of orifices direct the fluid into the valve bore at multiple locations about the valve bore.

Accordingly, the subject invention directs the power steering fluid into the valve bore through a plurality of orifices. By increasing the number of orifices through which the fluid enters the valve bore, the flow area through which the fluid flows is increased, which decreases the velocity of the fluid through the orifices. The decreased velocity reduces vibration in the steering valve and thereby reduces the undesirable “hissing” noise.

### BRIEF DESCRIPTION OF THE DRAWINGS

Other advantages of the present invention will be readily appreciated, as the same becomes better understood by reference to the following detailed description when considered in connection with the accompanying drawings.

FIG. 2 is a schematic view of a power steering system.

FIG. 3 is a cross sectional view of a first embodiment of a gear housing of the power steering system.

FIG. 4 is a cross sectional view of a second embodiment of a gear housing of the power steering system.

### DETAILED DESCRIPTION OF THE INVENTION

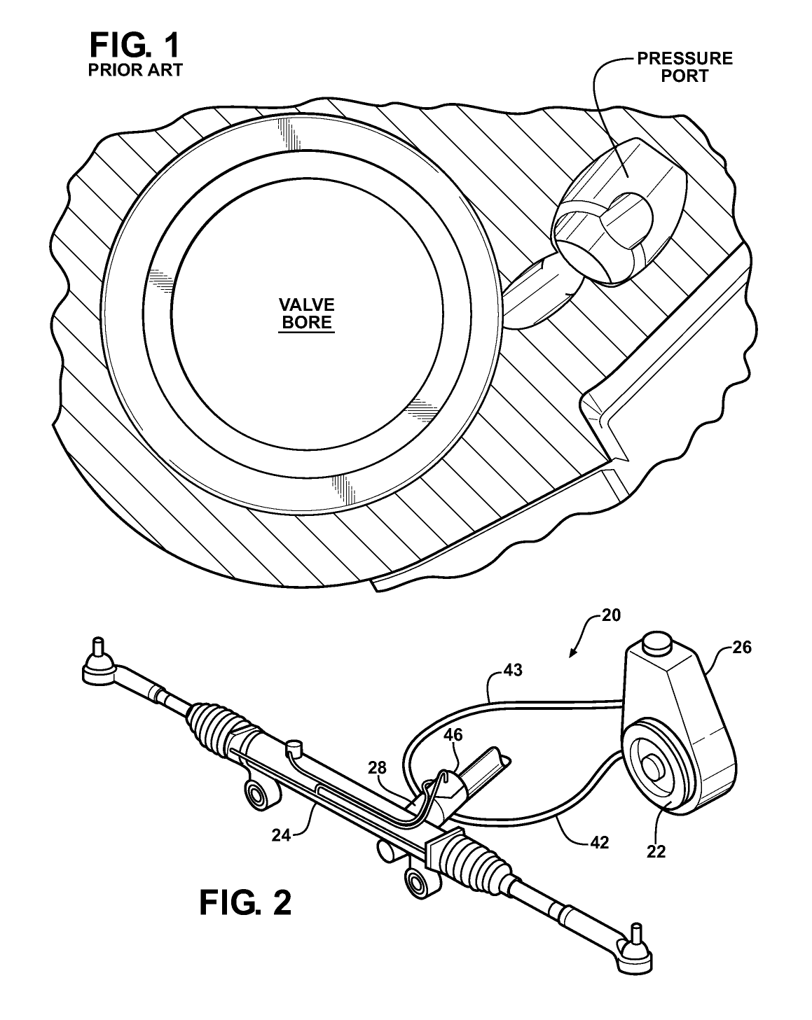

Referring to the Figures, wherein like numerals indicate corresponding parts throughout the several views, a power steering system is shown at 20 in FIG. 2. The power steering system 20 described herein is commonly referred to as a rack and pinion steering system 20. However, it should be appreciated that the subject invention may be incorporated into and used with other types of power steering systems 20.

Referring to FIG. 2, the power steering system 20 includes a pump 22, a steering gear 24 and a reservoir 26. The reservoir 26 stores a supply of a power steering fluid. The pump 22 is in fluid communication with the reservoir 26 and in fluid communication with the steering gear 24. The steering gear 24 is in fluid communication with the reservoir 26. The fluid circulates from the pump 22, through the steering gear 24, and back to the reservoir 26. The pump 22 pressurizes the power steering fluid and circulates the power steering fluid through the power steering system 20, i.e., from the reservoir 26 to the steering gear 24, and from the steering gear 24 back to the reservoir 26.

The steering gear 24 includes a gear housing 28. The gear housing 28 defines a pressure port 30, a valve bore 32, a plurality of orifices 34, 36 and a plurality of passageways 38, 40. The pressure port 30 is in fluid communication with the pump 22. The pressure port 30 receives the pressurize fluid from the pump 22. A first fluid line 42 connects the pump 22 with the gear housing 28 of the steering gear 24, and is attached to the steering gear 24 at the pressure port 30. A second fluid line 43 connects the gear housing 28 with the reservoir 26.

The valve bore 32 extends along a bore axis 44. A steering valve 46 is disposed within the valve bore 32. The steering valve 46 directs the power steering fluid to one of a first chamber and a second chamber of a power piston disposed within or adjacent to the gear housing 28 to assist in moving the rack as is known in the art.

The plurality of orifices 34, 36 is in fluid communication with and open into the valve bore 32. The plurality of passageways 38, 40 interconnect the plurality of orifices 34, 36 and the pressure port 30. Accordingly, the plurality of orifices 34, 36 are also in fluid communication with the pressure port 30. The plurality of orifices 34, 36 direct the power steering fluid into the valve bore 32 at multiple locations about the valve bore 32. Each of the plurality of orifices 34, 36 is disposed angularly about the bore axis 44 relative to all other of the plurality of orifices 34, 36. By having the plurality of orifices 34, 36 introduce the power steering fluid, i.e., permit flow of the power steering fluid into, the valve bore 32, the flow of the power steering fluid is balanced, thereby reducing vibration of the steering valve 46 at high flows of the power steering fluid. The reduced vibration of the steering valve 46 reduces or eliminates the undesirable “hissing” noise heard by the occupants of the vehicle.

It should be appreciated that the gear housing 28 may define any number of orifices 34, 36 opening into the valve bore 32, and that the plurality of orifices 34, 36 may be disposed at any desirable location about the bore axis 44. For example, the plurality of orifices 34, 36 may include four orifices 34, 36 equally spaced about the bore axis 44, i.e., spaced ninety degrees apart from each other. Alternatively, the plurality of orifices 34, 36 need not be spaced equidistant from each other, and may be randomly spaced about the bore axis 44.

The gear housing 28 may include a valve housing 48. The valve housing 48 may define the valve bore 32, the pressure port 30, the plurality of orifices 34, 36 and the plurality of passageways 38, 40. The valve housing 48 may be integrally formed with the gear housing 28. Alternatively, the valve housing 48 may be a separate component rigidly connected to the gear housing 28.

As shown, the plurality of passageways 38, 40 includes a first passageway 38 and a second passageway 40, and the plurality of orifices 34, 36 includes a first orifice 34 and a second orifice 36. The first orifice 34 is in fluid communication with the first passageway 38, and the second orifice 36 is in fluid communication with the second passageway 40.

It should be appreciated that the pressure port 30 is an opening that extends into the gear housing 28. Accordingly, the pressure port 30 extends along a port axis 50. It should be appreciated that the port axis 50 may be disposed in any desirable orientation to accommodate differing design and space restraints. It should be further appreciated that the orientation of the port axis 50 is not related to the bore axis 44.

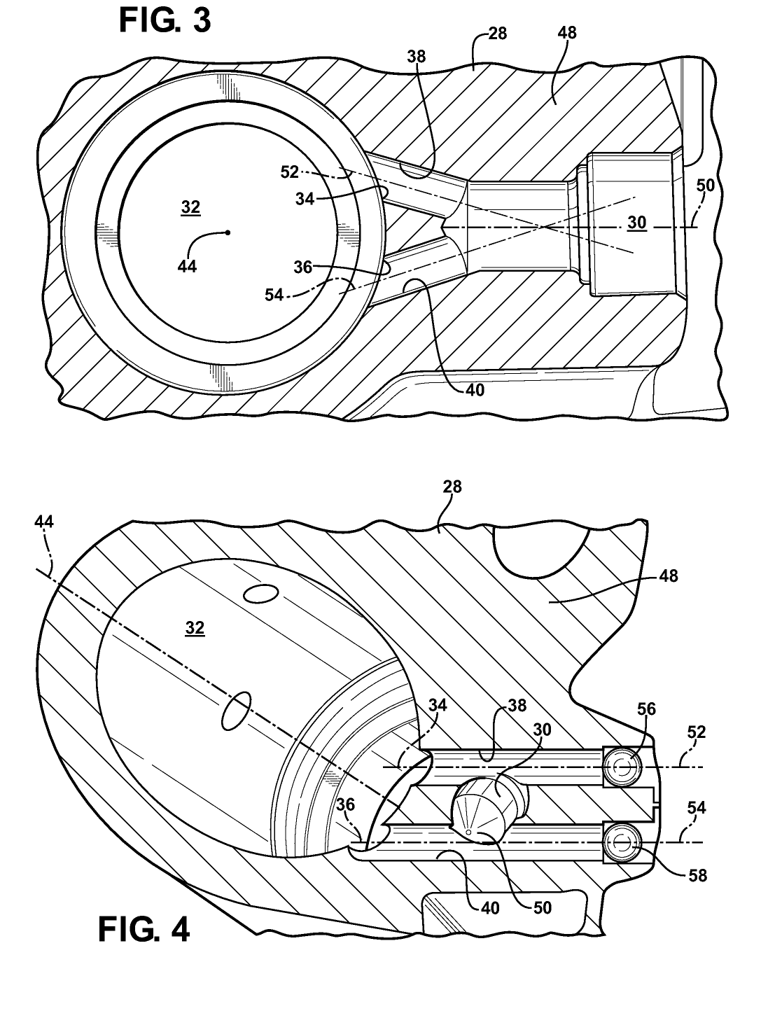

Referring to FIG. 3, a first embodiment of the gear housing is shown. The first embodiment of the gear housing 28 includes the pressure port 30, and thereby the port axis 50, extending into the gear housing 28 in a direction generally transverse to the valve bore 32. In the first embodiment of the gear housing 28, at least one of the plurality of passageways 38, 40, i.e., at least one of the first passageway 38 and the second passageway 40, is co-planar with the port axis 50. As shown, both the first passageway 38 and the second passageway 40 are coplanar with the port axis 50. The first passageway 38 extends along a first axis 52, and the second passageway 40 extends along a second axis 54. The first axis 52 intersects the second axis 54. Accordingly, the first passageway 38 and the second passageway 40 are angled relative to each other, and form an acute angle therebetween.

It should be appreciated that the power steering fluid enters the gear housing 28 through the pressure port 30, flows through the first passageway 38 and the second passageway 40 to the first orifice 34 and the second orifice 36 respectively, and into the valve bore 32. Once the power steering fluid enters the valve bore 32, the steering valve 46 directs the power steering fluid to one of the first chamber and the second chamber of the power piston as is well known.

In manufacture of the first embodiment of the gear housing 28, the pressure port 30 is machined into the gear housing 28 first. After which, the first passageway 38 and the second passageway 40 are machined into the gear housing 28 via the pressure port 30, and into the valve bore 32.

Referring to FIG. 4, a second embodiment of the gear housing is shown. The second embodiment of the gear housing 28 includes the port axis 50 being disposed in a generally parallel relationship relative to the valve bore 32. At least one of the first passageway 38 and the second passageway 40 are disposed along a plane intersecting the port axis 50. As shown, the plane is perpendicular to the port axis 50. However, it should be appreciated that the plane need only be substantially perpendicular to the port axis 50, i.e., the plane may be disposed at an approximate, but not quite, perpendicular angle relative to the port axis 50.

As shown in the second embodiment of the gear housing 28, the first passageway 38 and the second passageway 40 are co-planar. Additionally, the first passageway 38 and the second passageway 40 are parallel. A first plug 56 and a second plug 58 are disposed at a distal end of the first passageway 38 and the second passageway 40 respectively.

In manufacture, the pressure port 30 is machined into the gear housing 28. After which, the first passageway 38 and the second passageway 40 are machined into the gear housing 28, and at least partially intersect the pressure port 30. The first passageway 38 and the second passageway 40 are machined past the pressure port 30 and into the valve bore 32. The first plug 56 and the second plug 58 seal the first passageway 38 and the second passageway 40 respectively, so that the power steering fluid does not leak from the gear housing 28. Accordingly, it should be appreciated that the power steering fluid flows into the pressure port 30, through the first passageway 38 and the second passageway 40 to and through the first orifice 34 and the second orifice 36 respectively. The first plug 56 and the second plug 58 prevent the power steering fluid from flowing through the first passageway 38 and the second passageway 40 in a direction away from the first orifice 34 and the second orifice 36 respectively.

It should be appreciated that the gear housing 28 may also define a plurality of pressure ports 30, with one of the plurality of passageways 38, 40 interconnecting each of the plurality of pressure ports 30 with one of the plurality of orifices 34, 36.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A power steering system for a vehicle, said system comprising:
a reservoir for storing a supply of a fluid;
a pump in fluid communication with said reservoir for pressurizing and circulating the fluid;
a gear housing defining a pressure port in fluid communication with said pump for receiving the pressurized fluid from said pump;
said gear housing defining a valve bore and a plurality of orifices in fluid communication with said valve bore and said pressure port for directing the fluid into said valve bore at multiple locations about said valve bore.

2. A system as set forth in claim 1 wherein said valve bore extends along a bore axis and wherein each of said plurality of orifices is disposed angularly about said bore axis relative to all other of said plurality of orifices.

3. A system as set forth in claim 2 further comprising a plurality of passageways interconnecting said plurality of orifices and said pressure port.

4. A system as set forth in claim 3 wherein said plurality of passageways includes a first passageway and a second passageway and said plurality of orifices includes a first orifice in fluid communication with said first passageway and a second orifice in fluid communication with said second passageway.

5. A system as set forth in claim 4 wherein said pressure port extends along a port axis and at least one of said first passageway and said second passageway is co-planar with said port axis.

6. A system as set forth in claim 5 wherein both said first passageway and said second passageway are coplanar with said port axis.

7. A system as set forth in claim 6 wherein said first passageway extends along a first axis and said second passageway extends along a second axis intersecting said first axis.

8. A system as set forth in claim 4 wherein said pressure port extends along a port axis and at least one of said first passageway and said second passageway is disposed along a plane intersecting said port axis.

9. A system as set forth in claim 8 wherein said plane is perpendicular to said port axis.

10. A system as set forth in claim 8 wherein said first passageway and said second passageway are co-planar.

11. A system as set forth in claim 10 wherein said first passageway and said second passageway are parallel.

12. A system as set forth in claim 1 wherein said gear housing includes a valve housing defining said valve bore, said pressure port, said plurality of orifices and said plurality of passageways.

13. A system as set forth in claim 1 further comprising a steering valve disposed within said valve bore.

14. A system as set forth in claim 1 wherein said gear housing is in fluid communication with said reservoir for returning the fluid back to the reservoir.

15. A gear housing for a power steering system of a vehicle, said housing comprising:
a valve housing defining a valve bore and a pressure port for receiving a pressurized fluid;
said valve housing defining a plurality of orifices in fluid communication with said valve bore and a plurality of passageways in fluid communication with and interconnecting said plurality of orifices and said pressure port for directing the fluid from the pressure port into said valve bore at multiple locations about said valve bore.

16. A gear housing as set forth in claim 15 wherein said valve bore extends along a bore axis and wherein each of said plurality of orifices is disposed angularly about said bore axis relative to all other of said plurality of orifices.

17. A gear housing as set forth in claim 16 wherein said plurality of passageways includes a first passageway and a second passageway and said plurality of orifices includes a first orifice in fluid communication with said first passageway and a second orifice in fluid communication with said second passageway.

18. A gear housing as set forth in claim 17 wherein said pressure port extends along a port axis and at least one of said first passageway and said second passageway is co-planar with said port axis.

19. A gear housing as set forth in claim 18 wherein both said first passageway and said second passageway are coplanar with said port axis.

20. A gear housing as set forth in claim 19 wherein said first passageway extends along a first axis and said second passageway extends along a second axis intersecting said first axis.

21. A gear housing as set forth in claim 17 wherein said pressure port extends along a port axis and at least one of said first passageway and said second passageway is disposed along a plane intersecting said port axis.

22. A gear housing as set forth in claim 21 wherein said plane is perpendicular to said port axis.

23. A gear housing as set forth in claim 21 wherein said first passageway and said second passageway are co-planar.

24. A gear housing as set forth in claim 23 wherein said first passageway and said second passageway are parallel.
